(19) United States
(12) Patent Application Publication
(10) Pub. No.: US 2016/0249184 A1
(43) Pub. Date: Aug. 25, 2016

(54) METHOD FOR TRANSMITTING BROADCAST MESSAGE USING DATA NETWORK AND PUBLIC NETWORK

(71) Applicant: INFOZONE CO., LTD., Seoul (KR)

(72) Inventor: HI SUK LEE, Seoul (KR)

(21) Appl. No.: 15/031,428

(22) PCT Filed: Oct. 23, 2014
(86) PCT No.: PCT/KR2014/010007

§ 371 Date: Apr. 22, 2016

(30) Foreign Application Priority Data
Oct. 25, 2013 (KR) 10-2013-0127510

(51) Int. Cl. H04W 4/06; H04W 72/00; H04L 12/18

(52) U.S. Cl. CPC H04W 4/06; H04L 12/189; H04W 72/005

(57) ABSTRACT

The present invention relates to a method for transmitting a broadcast message using a data network and a public network, which not only transmits the broadcast message to at least one called terminal and ensures that the broadcast message can be received in the called terminal at a relatively low cost, but also solves problems caused by dual reception of the broadcast message. The present mention comprises: an eleventh step for receiving a request for transmission of a broadcast message; a twelfth step for comparing the telephone number of a called terminal with telephone number database of the called terminal having, installed therein, an app for receiving the broadcast message; a thirteenth step for a broadcast message transmission server transmitting the broadcast message through a data network if the called terminal corresponds to the number of the called terminal having the app installed therein; a fourteenth step for receiving a broadcast message reception completion message as feedback from the app of the called terminal; a fifteenth step for acknowledging that the broadcast message has been received normally in the called terminal when receiving the broadcast message reception completion message; and a sixteenth step for displaying the broadcast message in the app, the present invention further comprising a twenty-first step for the broadcast message transmission server transmitting the broadcast message through a public network if the called terminal does not correspond to the number of the called terminal having the app therein, in the twelfth step, or if the broadcast message transmission server does not receive the broadcast message reception completion message as feedback from the app of the called terminal in the fourteenth step; and a twenty-second step for displaying, in the called terminal, the broadcast message transmitted through the public network.

### TECHNICAL FIELD

The present invention relates to a method for transmitting a broadcast message using a data network and a public network. More particularly, the present invention to a method for transmitting a broadcast message using a data network and a public network, in which in case a broadcast message is transmitted to one or more destination terminals in accordance with a request for transmitting a broadcast message sent by a caller terminal, the broadcast message is transmitted through a data network, when a telephone number of the destination terminal is a smart phone provided with an app (application). On the other hand, when the destination terminal is a mobile phone incapable of receiving a broadcast message via an app, or a smart phone in which an app is not installed, or when it is uncertain whether or not the broadcast message transmitted through a data network is received by the destination terminal, the broadcast messages can be transmitted through a public network of a communication service provider, such that the broadcast message can be transmitted, without failure, to a destination terminal at a low cost and a problem regarding double reception of a broadcast message transmitted through a public network can be solved, in case that whether the broadcast message transmitted through a data network is received by a destination terminal is uncertain.

### BACKGROUND OF THE DISCLOSURE

Recently, with the advancement in technologies relating to an internet and a mobile communication, a trend in which companies having many customers provide various information to their customers in various ways is growing.

In accordance with such a trend, a method of providing customers with information through an email message, voice, FAX, a text message, or SNS has been searched, which has led to a high cost and investment. In general, in order to provide customers with various information in the form of text or voice messages other than email transmission, the messages can be transmitted in such a way as to establish a message transmission system or utilize a service provider providing message transmission service.

The service providers selectively choose either a data network or a mobile network for the message transmission, when required to transmit business messages, depending on the kind of destination and caller terminals, thereby minimizing a cost to transmit the messages.

Korean Patent No. 10-1089709 discloses a call connection apparatus capable of connecting a communication line of a mobile terminal equipped with an application for connecting a call, and a method for connecting a call using the same. According to the disclosure, a call management unit picks a line causing a cheapest call rate among the service lines possessed by the service provider and uses it as a caller line and a destination line, so as to generate a destination call and a caller call. The plurality of the service lines are either a packet network or a circuit network, and when a circuit network is selected, a cheapest line therein can be used.

Referring to FIG. 4, when a network configuration of a caller terminal is in a condition capable of using both packet and circuit networks, call connection information inputted to the caller terminal is transmitted to the call connection apparatus through a packet network (S115).

The call management unit identifies caller information from the call connection information stored in the call connection apparatus, and then selects a caller line capable of generating a call connection with a caller terminal, among the lines possessed by the service provider operating the call connection apparatus (S120). In this case, the caller line is selected such that the call rate generated between the call connection apparatus and the caller terminal remains cheapest.

In this case, the caller line is connected through one of a packet network and a circuit network, and since both caller and destination lines can be selected in the packet network, a free call can be made between a caller terminal and a destination terminal.

However, such call connection apparatus can reduce a cost for transmitting a message or a call by selecting a cheaper hue out of a packet network and a circuit network. Nevertheless, in case a message is transmitted through a packet network, instability thereof often results in problems, particularly when a message must be received by a destination terminal.

### SUMMARY

Even though a reduced cost may be accomplished upon transmitting the broadcast message through a data network, embodiments of present invention provide a method of enabling broadcast messages to be certainly received by a destination terminal by means of a public network, in addition to saving a cost by utilizing a data network, even in case of instability of a data network, for the companies which want broadcast messages to be transmitted to customers.

Further, an exemplary embodiment of the present invention provides a method of preventing a broadcast message transmitted through a date network and a public network, respectively, from being doubly received by the destination terminal when the broadcast message is transmitted therethrough.

According to an embodiment of present invention, the method for transmitting a broadcast message using a data network and a public network includes the steps of receiving, by a broadcast message transmission server, a request for transmitting a broadcast message transmitted from a caller terminal (S11); comparing, by the broadcast message transmission server, a telephone number of a target destination terminal to which the broadcast message is transmitted with a telephone numbers database of an app-installed destination terminal equipped with an app for receiving the broadcast message (S12); transmitting, by the broadcast message transmission server, the broadcast message to the destination terminal through a data network when the telephone number of the destination terminal corresponds to the telephone number of the app-installed destination terminal (S13); receiving, by the broadcast message transmission server, a feedback of a reception confirmation for the broadcast message from the app of the destination terminal (S14); confirming, by the broadcast message transmission server, that the broadcast message is normally transmitted to the destination terminal when the broadcast message transmission server receives the reception confirmation from the destination terminal (S15); and displaying the broadcast message in the app of the destination terminal (S16).

The method for transmitting a broadcast message using a data network and a public network further includes the steps of: transmitting, by the broadcast message transmission server, the broadcast message through a public network when the telephone number of the target destination terminal is not the app-installed destination terminal in step S12 or when the broadcast message transmission server does not receive the reception confirmation for the broadcast message from the app of the destination terminal in step S14 (S21); and displaying, by the broadcast message transmission server, the broadcast message transmitted through the public network on the destination terminal (S22).

According to an embodiment of the present invention the broadcast message is transmitted using a public network, upon instability of a data network, and thus must be received by the destination terminal, in addition to saving a cost by using a data network, for the companies which want the broadcast message to be received, without failure, by the destination terminal.

Further, according to an embodiment of the present invention, when the broadcast message is transmitted using both date and public networks, confusion of a user may be prevented by preventing the broadcast messages transmitted through the date network and the public network, respectively, from being doubly received by the destination terminal.

### BRIEF DESCRIPTION OF THE DRAWINGS

FIG. 1 is a flow chart illustrating a method for transmitting a broadcast message using a data network and a public network according to an exemplary embodiment of the present invention;

FIG. 2 is a flow chart illustrating a method of displaying a broadcast message in consideration of double reception of the broadcast message according to an exemplary embodiment of the present invention;

FIG. 3 is a flow chart illustrating a processing procedure when a non-confirmation setting mode for the broadcast message is set; and

FIG. 4 is a view illustrating a call connection method for connecting communication lines of mobile terminals equipped with an application therein for the call connection according to an embodiment of the related art.

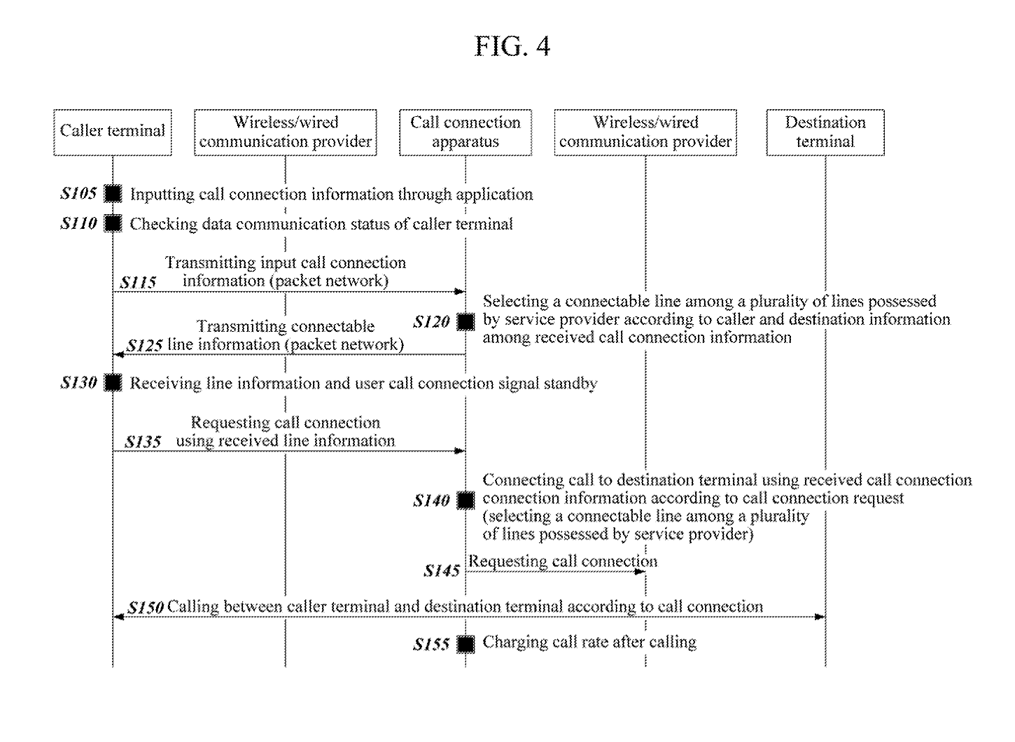

### DETAILED DESCRIPTION OF EXEMPLARY EMBODIMENTS

The terms or words used in the specification and the claims should not be interpreted as limited to typical or dictionary meanings, and they should rather be construed to comply with the technical spirit of the invention under the principle that the concepts of terms may be properly defined in such a way as to best describe the invention.

Therefore, it should be appreciated that the configurations shown and described in the specification and the drawings are merely preferable embodiments of the present invention, rather than representing all technical, spirits of the present invention and that various changes, modifications, replacements, or equivalents may be made thereto at the time of filing the instant application.

Hereinafter, preferred embodiments of the present invention are described in detail with reference to the accompanying drawings.

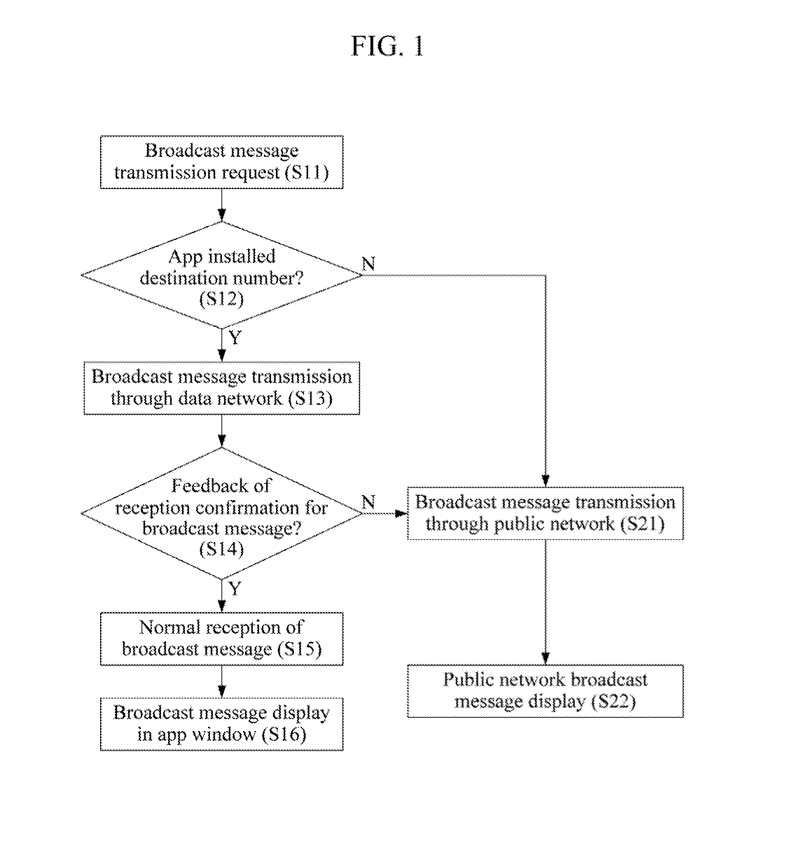

FIG. 1 is a flow chart illustrating, a method for transmitting a broadcast message using a data network and a public network according to an exemplary embodiment of the present invention. As shown in FIG. 1, according to the method for transmitting a broadcast message using data and public networks, a broadcast message transmission server receives a transmission request for the broadcast message, which is transmitted from a caller terminal, such as a customers computer, a communication terminal, etc. (S11). The transmission request includes a broadcast message content and a telephone number of a destination terminal (in an example case, such telephone number may be previously stored per customer in the transmission server).

The broadcast message transmission server compares a telephone number of the destination terminal to which the broadcast message is transmitted with a telephone number database of an app-installed destination terminal equipped with an app for receiving the broadcast message, and determines whether or not the telephone number of the destination terminal corresponds to the telephone number of the app-installed destination terminal in the database (S12). When it corresponds to the telephone number of the app-installed destination terminal in the database, the broadcast message transmission server transmits the broadcast message through a data network, resulting in a free or reduced call rate to transmit the broadcast message (S13).

In response to the broadcast message transmitted by the broadcast message transmission server, the app installed in the destination terminal sends out a feedback that the broadcast message is received by the destination terminal to the broadcast message transmission server (S14). When the broadcast message transmission server receives such a feedback of a reception confirmation, the broadcast message is displayed on the app of the destination terminal (S15 and 516), thereby making it unnecessary to re-transmit the broadcast message through a separate public network and accomplishing a reduced call rate required for transmitting the broadcast message.

However, when the app for receiving a broadcast message is not installed in the destination terminal, so the broadcast message is not able to be transmitted through a data network, or despite the app installed therein, the app is not able to send out the feedback of the reception confirmation to the broadcast message transmission server, e.g., due to a network instability, an off status of the destination terminal, or an exceeded date limit, the broadcast message is not able to be transmitted through the data network, or it is uncertain whether the broadcast message is received by the destination terminal although the broadcast message is transmitted through the data network.

In this case, the broadcast message transmission server re-transmits the broadcast message through a public network, regardless of whether the broadcast message transmitted through the data network is received by the destination terminal, to thus accomplish a reception of the broadcast message by the destination terminal (S21), and the destination terminal displays the broadcast message transmitted through the public network (S22).

Here, the broadcast message transmission server receives the feedback of the reception confirmation for the broadcast message for a predetermined time, after transmitting the broadcast message, to determine whether or not the broadcast message is received by the destination terminal.

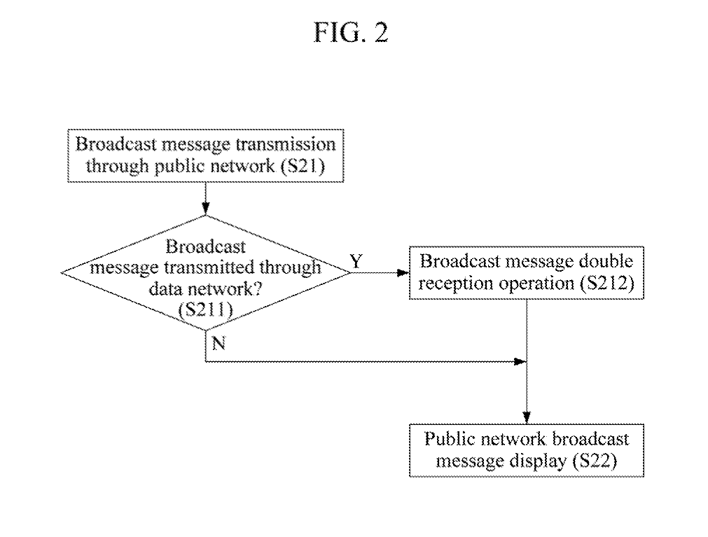

FIG. 2 is a flow chart illustrating a method of displaying a broadcast message in consideration of double reception of the broadcast message according to an exemplary embodiment of the present invention. As depicted in FIG. 2, in order to enable the broadcast message to be received by the destination terminal, there exists a possibility that the broadcast message is doubly transmitted through both data and public networks, when the broadcast message transmission server does not receive the feedback of the reception confirmation from the destination terminal, even though the destination terminal is provided with an app. The app installed in the destination terminal determines whether the broadcast message received by the destination terminal is transmitted through the date network or not, so as to confirm such double transmission.

Based on the determination, when the broadcast message transmitted through the data network is not received by the destination terminal, the broadcast message transmitted through the public network is displayed in the destination terminal (S22). In contrast, when the broadcast message transmitted through the data network is received by the destination terminal, an operation of double reception is performed according to dual reception, by the destination terminal, of the broadcast message transmitted through the data network and the public network (S212), and the broadcast message that is transmitted through the public, network is then displayed in the destination terminal (S22).

Various types of operations are possible to show that the broadcast message is doubly received, such as an operation of displaying in the app of the destination terminal the dual reception of the broadcast message, an operation of deactivating where the broadcast message received by the app of the destination terminal is not displayed, an operation of deleting the broadcast message received by the app of the destination terminal, or a combination thereof, such that an user acknowledges the double reception of the broadcast message. Alternatively, a state in which the broadcast message cannot be displayed in the app of the destination terminal (e.g., deactivation or deletion) may be achieved, thereby removing inconvenience resulting from the double reception of the broadcast message for the user.

The app installed in the destination terminal compares information of the broadcast message, such as a caller, a calling time, a content or their combinations, transmitted through a data network with that transmitted through a public network to determine whether such double reception of the broadcast message has occurred. Particularly, comparison as to the calling time can be preferably made between a sum of a predetermined feedback time and a calling time when the broadcast message is transmitted through the data network and a calling time when the broadcast message is transmitted through the public network.

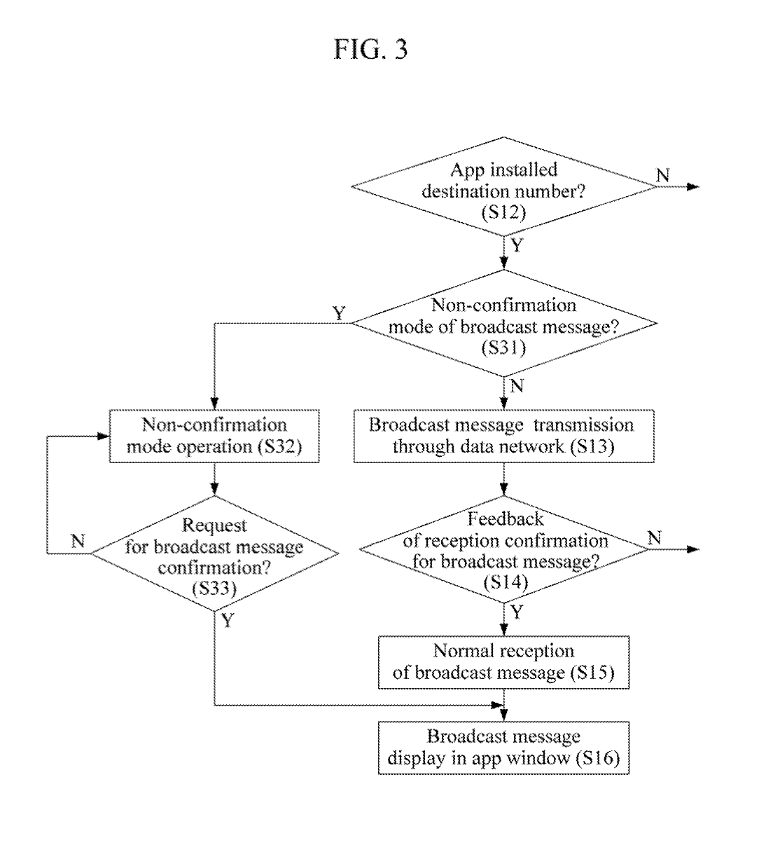

FIG. 3 is a flow chart illustrating a processing procedure when a non-confirmation setting mode for the broadcast message is set. As illustrated in FIG. 3, the broadcast message transmission server compares a telephone number of the destination terminal to which the broadcast message is transmitted with a telephone number database of an app-installed destination terminals having an app for receiving the broadcast message, to determine whether the telephone number of the destination terminal corresponds to the telephone number of the app-installed destination, terminal in the database. If the telephone number of the destination terminal to which the broadcast message is transmitted is in the database (i.e., Y at S12), the method for transmitting a broadcast message using a data network and a public network according to an exemplary embodiment of the present invention may be further provided with a step S31 of determining whether or not the non-confirmation setting mode for the broadcast message is set, e.g., because of a limited reception time for the broadcast message or deferral of the reception due to a meeting by a user of the destination terminal, before transmitting the broadcast message through the data network.

Based on the determination in the step S31, the broadcast message transmission server transmits the broadcast message to the destination terminal via the data network when the destination terminal does not have the non-confirmation setting mode. On the other hand, when the destination terminal has the non-confirmation setting mode, an operation of the non-confirmation setting mode is performed (S32), such as deferral of transmission of the broadcast message, transmission and display of a portion of the broadcast message, transmission and deferral of display of the broadcast message on the app of the destination terminal.

The operation of the non-confirmation setting mode determines whether a confirmation request for the broadcast message is sent to the broadcast message transmission server by the destination terminal, and if no confirmation request is made (i.e., N at S33), the non-confirmation setting mode is continued. However, if there is a confirmation request from the destination terminal (i.e., Y at S33), the non-confirmation setting mode is lifted and the broadcast message is displayed on the app of the destination terminal (S17), by such a way that the broadcast message is downloaded from the broadcast message transmission server in a case of the transmission deferral, a rest or whole of the broadcast message is downloaded from the broadcast message transmission server in a case of transmission of the portion of the broadcast message, or a reception display is activated on the app of the destination terminal in a case of the display deferral.

1. A method for transmitting a broadcast message using a data network and a public network, the method comprising:
a step S11 of receiving, by a broadcast message transmission server, a request for transmitting a broadcast message transmitted from a caller terminal;
a step S12 of comparing, by the broadcast message transmission server, a telephone number of a target destination terminal to which the broadcast message is transmitted with a telephone number database of an app-installed destination terminal equipped with an app for receiving the broadcast message;
a step S13 of transmitting, by the broadcast message transmission server, the broadcast message to the destination terminal through a data network when the telephone number of the target destination terminal corresponds to the telephone number of the app-installed destination terminal;
a step S14 of receiving, by the broadcast message transmission server, a feedback of a reception confirmation for the broadcast message from the app of the destination terminal;
a step 515 of confirming, by the broadcast message transmission server, that the broadcast message is normally transmitted to the destination terminal when the broadcast message transmission server receives the reception confirmation from the destination terminal; and
a step S16 of displaying the broadcast message in the app of the destination terminal, wherein the method further comprises:
a step S21 of transmitting, by the broadcast message transmission server, the broadcast message through a public network when the telephone number of the target destination terminal is not the app-installed destination terminal in step S12 or when the broadcast message transmission server does not receive the reception confirmation for the broadcast message from the app of the destination terminal in step S14; and
a step S22 of displaying, by the broadcast message transmission server, the broadcast message transmitted through the public network on the destination terminal.

2. The method of claim 1, wherein, in the step 514, the broadcast message transmission server receives the feedback of the reception confirmation of the broadcast message for a predetermined time after the broadcast message is transmitted to the destination terminal.

3. The method of claim 1, further comprising a step S211 in which the app installed in the destination terminal determines, after the step S21, whether the broadcast message transmitted through the data network is received by the destination terminal.

4. The method of claim 3, wherein the broadcast message transmitted through the public network is displayed on the destination terminal when the broadcast message transmitted through the data network is not received by the destination terminal in the step S211.

5. The method of claim 3, further comprising a step S212 of performing an operation of double reception according to dual reception, by the destination terminal, of the broadcast message transmitted through the data network and the public network when the broadcast message transmitted through the data network is received by the destination terminal in the step 211,
wherein the broadcast message transmitted through the public network is displayed on the destination terminal after the step S212.

6. The method of claim 5, wherein the operation of double reception in the step S212 includes any one or more of an operation of displaying in the app of the destination terminal the dual reception of the broadcast message through the data network and the public network, an operation of deactivating the broadcast message received by the app of the destination terminal, or an operation of deleting the broadcast message received by the app of the destination terminal.

7. The method of claim wherein the app installed in the destination terminal determines whether the broadcast message is doubly received by the destination terminal, by making a comparison as to a caller, a calling time, a content of the broadcast message, or a combination thereof.

8. The method of claim 7, wherein the comparison as to the calling time is made between a sum of a predetermined feedback time and a calling time when the broadcast message is transmitted through the data network and a calling time when the broadcast message is transmitted through the public network.

9. The method of claim 1, further comprising the step of S31 of determining whether the non-confirmation setting mode is set at the destination terminal between S12 and S13.

10. The method of claim 9, wherein the step S13 is performed when the destination terminal does not have the non-confirmation setting mode in the step S31, and wherein the method further comprises a step S32 of operating any one or more non-confirmation setting modes of deferral of transmission of the broadcast message, transmission and display of a portion of the broadcast message, or transmission and deferral of display of the broadcast message on the app of the destination terminal in case the destination terminal has the non-confirmation setting mode.

11. The method of claim 10, wherein it is determined whether a confirmation request for the broadcast message is sent by the destination terminal after the step S32, and the non-confirmation setting mode operation in the step S32 is continued if no confirmation request is made, and if there is the confirmation request from the destination terminal, a step S33 is further provided, in which the broadcast message is downloaded from the broadcast message transmission server in a case of the transmission deferral, a rest or whole of the broadcast message is downloaded from the broadcast message transmission server in a case of the transmission of the portion of the broadcast message, or a reception display is activated on the app of the destination terminal in a case of the display deferral, and the broadcast message is displayed in the app of the destination terminal.

12. The method of claim 6, wherein the app installed in the destination terminal determines whether the broadcast message is doubly received by the destination terminal, by making a comparison as to a caller, a calling time, a content of the broadcast message, or a combination thereof.
